(19) United States
(12) Patent Application Publication
(10) Pub. No.: US 2012/0246082 A1
(43) Pub. Date: Sep. 27, 2012

(54) Passenger Extraction Program and a Method of Extraction

(75) Inventors: Michael Forte, Austin, TX (US); Adam Weiss, Las Vegas, NV (US)

(73) Assignee: Extraction Zones LLC

(21) Appl. No.: 13/423,175

(22) Filed: Mar. 17, 2012

Related U.S. Application Data
(60) Provisional application No. 61/465,320, filed on Mar. 17, 2011.

(51) Int. Cl. G06F 3/048; G06Q 10/00

(52) U.S. Cl. 705/306; 715/810

(57) ABSTRACT

The extraction program and method of extraction of the present invention can be utilized by emergency response personnel to safely extract passengers from a vehicle and handle hazardous chemical spills. Another embodiment of the present invention provides for vehicle make and model recognition technology. Another embodiment provides for damage estimates to be given in a speedy manner.

### CROSS REFERENCE TO RELATED APPLICATIONS

This application claims priority to U.S. Provisional Application 61/465,320 filed Mar. 7, 2011.

### STATEMENT REGARDING FEDERALLY SPONSORED RESEARCH OR DEVELOPMENT

Not Applicable

### REFERENCE TO SEQUENCE LISTING

Not Applicable

### BACKGROUND

When responding to a vehicle accident or emergency, emergency response personnel are regularly faced with the task of physically removing injured and/or trapped passengers from a damaged vehicle. At times, the vehicle is so damaged that emergency response personnel must disassemble or cut away a portion of the vehicle.

When disassembling or cutting away a portion of a vehicle, the personnel must do so with great care, as improper methods may cause injury or death to the passenger(s) and/or response personnel. For example, cuts made in the wrong location on a vehicle may cause airbag deployment, gas explosions and fire, or electrical fires.

Another concern when extracting passengers from damaged vehicles is the fact that some modern vehicles are manufactured with ultra high strength materials, such as ultra-high-strength-steel, particularly in select structural areas of a vehicle. Currently, the piston-rod hydraulic tools available to response personnel, which include cutters, spreaders and rams, are not capable of cutting through ultra high strength materials in the vehicles. When response personnel attempt to cut through such materials, not only do they risk damaging the tools beyond repair, but they also lose valuable time in life-and-death situations. Passenger lives have been lost as personnel attempted to cut material that could not be cut.

It is also foreseeable that further development in manufacturing materials will continue to present response personnel with the inability to cut through certain vehicle components, even when the cutting tools are re-designed such that they are capable of making such cuts on materials currently available.

Another problem faced by response personnel is the situation in which damaged vehicles are transporting hazardous chemicals. Response personnel must treat these situations accordingly to avoid injury or loss of life to passengers and others.

In an attempt to address the above problems, response personnel have generally referred to bound books, vehicle manufacturing data, and online forums. Such referencing, however, is unwieldy, inefficient, inaccurate, and time-consuming in critical moments.

There thus remains a need to ensure that passengers are extracted and chemical spills are addressed in a safe and efficient manner.

There also exists a problem when it comes to insurance claims and estimates when a vehicle is damaged. At this time, it is sometimes difficult for insurance assessors to give a quick rough estimate based on a view of a vehicle. There is also little consistency between assessors. It is also sometimes a challenge to even discern the make of a vehicle that has been severely damaged. There thus remains a need to quickly and efficiently determine a vehicle make and model, and provide a speedy and consistent rough estimate of repair costs.

### SUMMARY

The extraction program and method of extraction of the present invention address the above problems by providing a mobile phone application. The application can be utilized by emergency response personnel to safely extract passengers from a vehicle and handle hazardous chemical spills. Another embodiment of the present invention provides for vehicle make and model recognition technology. Another embodiment provides for damage estimates to be given in a speedy manner.

### BRIEF DESCRIPTION OF THE DRAWINGS

FIG. 1 is a screen capture of a top level menu.

FIG. 2 is a screen capture of a second level menu.

FIG. 3 is a screen capture of a layer selection menu.

FIG. 4 is a screen capture of a vehicle side view in day mode, with layers selected as in FIG. 3.

FIG. 5 is a screen capture of a vehicle top view in day mode, with layers selected as in FIG. 3.

FIG. 6 is a screen capture of a vehicle side view in night ode, with layers selected as in FIG. 3.

FIG. 7 is a screen captures of a notes display for a vehicle.

FIG. 8 is a screen capture of a layer selection menu.

FIG. 9 is a screen capture of a vehicle side view in day mode, with layers selected as in FIG. 8.

FIG. 10 is a screen capture of a vehicle side view in night mode, with layers selected as in FIG. 8.

### DESCRIPTION

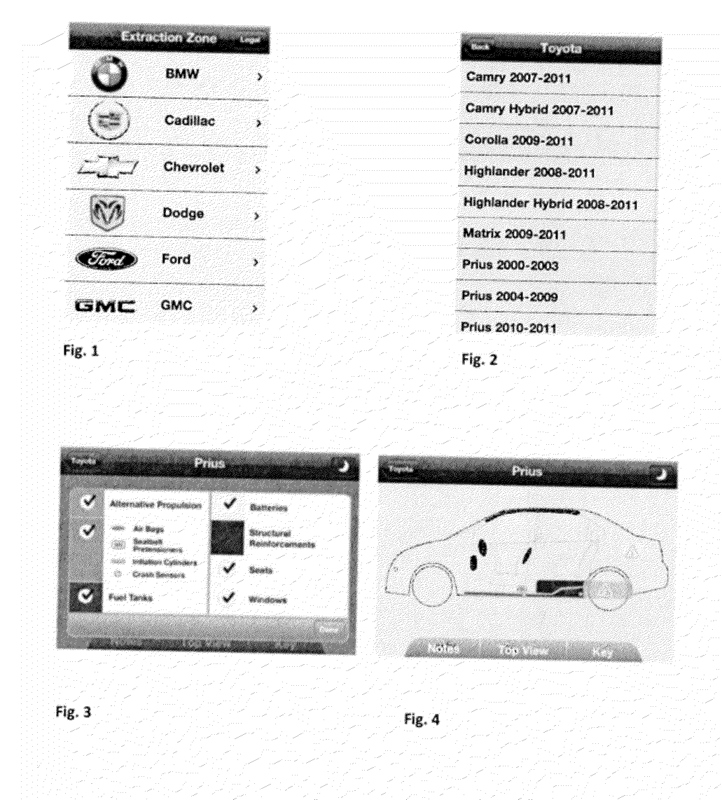

Referring now to FIG. 4, an aspect of the present invention is shown. In one embodiment of the mobile phone application, a user, generally emergency response personnel, may select through a top level and second level menu, as shown in FIG. 1 and FIG. 2, to reach a depiction of the vehicle at hand. In the example of FIG. 4, a Toyota Prius is selected; however, it should be understood that the program is capable of any number of domestic and foreign vehicles. It should also be understood that the top level and second level menus of FIG. 1 and FIG. 2 can be extended to include any number of domestic and foreign vehicles.

In FIG. 4, the side view of a Prius depicts the locations of critical components of interest in the vehicle. The term “components of interest” should be understood to include features that emergency response personnel should take into account when rescuing vehicle passengers. For example, the green features depict air bags, seatbelt pretensioners, inflation cylinders, and crash sensors. Fuel tanks are shown in red. Batteries are in yellow. By viewing the color coded features in this manner, emergency response personnel can determine the appropriate approach to extracting a passenger from the vehicle, and avoid deploying air bags, or cutting fuel containers, for example. Other color schemes are contemplated, and it should be understood by those skilled in the art that future car models can have components of interest that are not currently included in vehicles today. The present invention should be understood to be versatile enough to include an expanded definition of the term “components of interest” up to and including the entire vehicle assembly.

For clarity and to improve the ease of use, the user can preferably deselect one or more of the layers of critical components. For example, it can be determined from another selection menu, shown in FIG. 3, that structural reinforcements, normally shown in magenta, have been de-selected, and are thus not depicted in FIG. 4, or the top view FIG. 5. With the ability to select and de-select various layers, the user can concentrate on the most critical features for the particular job at hand without distraction. For example, all features besides the structural reinforcements may be de-selected, so that emergency response personnel can reliably view where it is safe to cut vehicle components away.

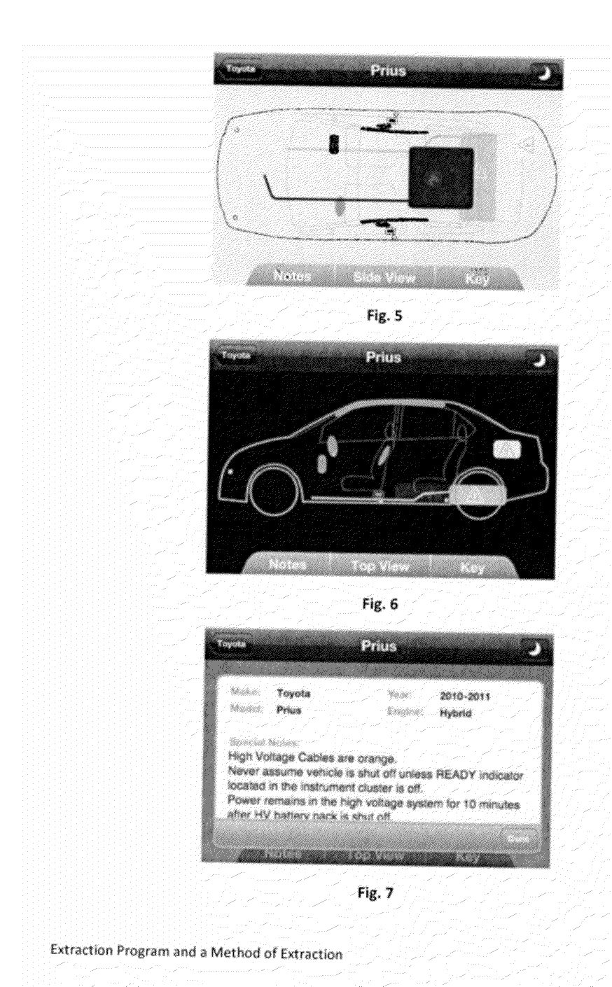

Often, vehicle accidents occur during the night. While using standard or day mode background and sketch colors on a mobile phone, emergency response personnel are commonly blinded and distracted by flashing lights, and have difficulty distinguishing between various colors and features on a mobile phone screen. The inventors of the present invention have solved this problem by providing a night mode for viewing, depicted in FIG. 6. In the night mode, the background of the mobile phone application is black, or a very dark color, thus enabling better color contrast and viewing at night. As depicted in FIG. 6, a night mode selection button may be provided on a touch screen mobile phone. It is also contemplated that night mode selection may be made via voice command.

Another embodiment (not shown) of the present invention provides for informing the user of proper handling methods of various hazardous chemicals. This may be achieved by accessing a virtual database of the various hazardous chemical symbols and the appropriate handling measures to take. As of the filing of this application, emergency response personnel are generally forced to refer to large bound books for information regarding various chemical hazard labels, and doing so costs them critical time when responding to incidents involving transporters of such chemicals.

Another embodiment of the present invention provides for zooming capabilities. Preferably, the user can use a swiping motion on a touch screen to zoom in on critical features, but it is also contemplated that this can be achieved via voice command. Access to top and side views are also desired.

It should be understood by those skilled in the art that it is contemplated that menu controls may be achieved by means of touch screen control, voice command, or button control.

In FIG. 7, a notes section is shown. Here, the user may view particular instructions regarding the vehicle selected in the top level menu and second level menu.

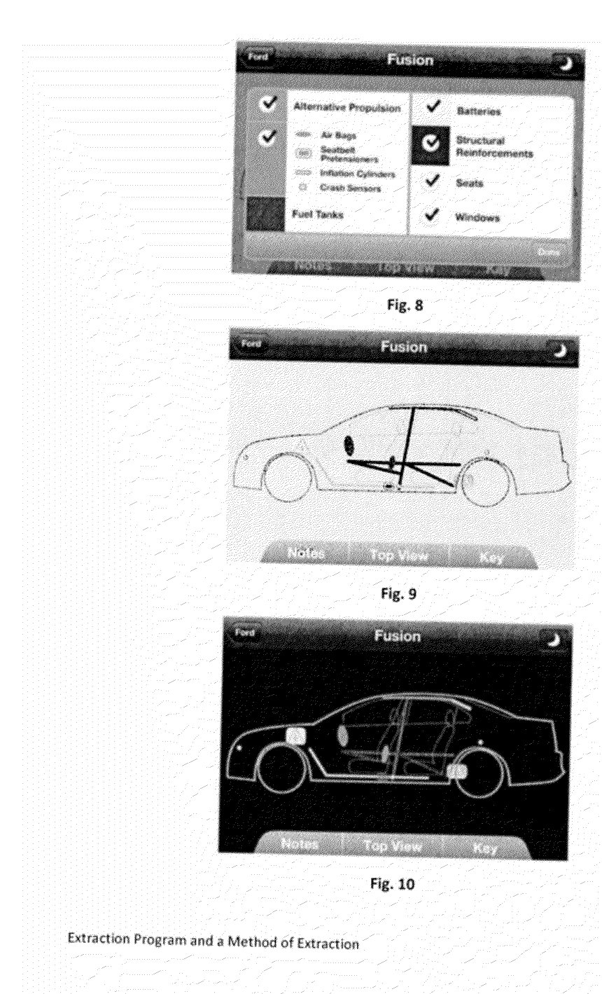

In FIG. 8, FIG. 9, and FIG. 10, a second vehicle is selected, in this case a Ford Fusion, and the structural reinforcements (magenta) are selected and shown in day mode, FIG. 9, and night mode, FIG. 10, while the fuel containers (red), are de-selected and not shown.

In another embodiment of the present invention, it is contemplated that the mobile phone application includes technology to identify vehicle makes and models by photographic recognition. In a preferred embodiment, data regarding vehicle makes and models is stored in the application itself, as part of the coding. In other words, the application does not rely on vehicle information through accessing the web. Instead, the development team updates the mobile application with new vehicles as needed with each release. The mobile application is then loaded to iTunes or another network location, where users may download updates at their own discretion.

Using photographic recognition is technology originally developed to identify people or faces. When applied to vehicles, and in relation to the present invention, the development team photographs a vehicle in multiple views. An algorithm, in the mobile phone application of the present invention, compares and matches features of the catalogued vehicle with a future vehicle, such as one that has been damaged.

Preferably, once a vehicle, perhaps damaged, has been matched to a catalogued vehicle, those portions that are damaged can be identified by the mobile phone application. Further catalogued information regarding roughly estimated repair cost expectations can be used to provide the user with a rough repair cost. The main advantage to using this technology to estimate repair costs is that such estimates are consistent across the country and among multiple users. Another advantage is that the user, such as an insurance claims adjuster, can arrive at a repair estimate in a matter of minutes instead of hours or days.

Data is accessed by choosing buttons/descriptions based on the user's desired outcome/vehicle. It is also contemplated that information be accessed via voice command, and using the internet (wifi or 3g/4g connections) to search and return “results” based options.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the claims.

What is claimed is:

1. A computer program product that is stored on a computer-readable medium and that includes computer program code which, when executed by a processor, causes the processor to:
display a user interface menu, said user menu providing a selection of vehicle makes and models from which a user can select,
display, upon selection by the user, a vehicle schematic in which various components of interest are displayed in color.

2. The computer program product of claim 1, comprising:
means to display the components of interest in grouped layers, and means for selecting and de-selecting the components of interest by group.

3. The computer program product of claim 2, wherein:
the grouped layers are color coded as follows:
green: depicts air bags, seatbelt pretensioners, inflation cylinders, and crash sensors,
red: depicts fuel conduits/containers,
yellow: depicts batteries,
magenta: depicts structural reinforcements.

4. The computer program product of claim 1, comprising:
means for user access to information regarding hazardous chemicals and the codes displayed on vehicles transporting hazardous chemicals, and
means for user access to notes regarding vehicles.

5. The computer program product of claim 1, comprising:
means to display vehicle schematics with components of interest in both a side view and top view,
means for the user to alternate between the side and top views,
means to display information in a day mode or night mode, and
means for user selection between day mode and night mode.

6. The computer program product of claim 1, comprising means for touch screen control, and/or means for voice control.

7. The computer program product of claim 1, comprising means for vehicle recognition.

8. The computer program product of claim 7, comprising means for displaying an estimated repair cost of damage to a recognized vehicle.

9. A method of extracting a passenger from a vehicle, comprising the steps of:
operating a mobile computer device,
selecting a vehicle make and model on said computer device,
viewing a vehicle schematic on said mobile computer device, in which various components of interest are displayed in color.

10. The method of claim 9, comprising the step of:
viewing the components of interest in grouped layers, and one or both of the following steps:
selecting the components of interest by group, and
de-selecting the components of interest by group.

11. The method of claim 10, wherein:
the grouped layers are color coded as follows:
green: depicts air bags, seatbelt pretensioners, inflation cylinders, and crash sensors,
red: depicts fuel conduits/containers,
yellow: depicts batteries,
magenta: depicts structural reinforcements.

12. The method of claim 9, comprising the step of accessing information regarding hazardous chemicals and the codes displayed on vehicles transporting hazardous chemicals by selecting a menu in the mobile computing device.

13. The method of claim 9, comprising:
accessing notes regarding vehicles by selecting a menu in the mobile computing device.

14. The method of claim 9, comprising one or both of the steps of:
viewing vehicle schematics with components of interest in both a side view and top view, and
alternating between the side and top views.

15. The method of claim 9, comprising one or both of the steps of:
viewing information in a night mode, and
alternating views between day mode and night mode.

16. A method of estimating repair costs on a damaged vehicle, comprising the steps of:
operating a mobile computer device, said mobile computer device comprising means to recognize a vehicle make and model via photographic recognition.

17. The method of claim 16, comprising the step of matching a damaged vehicle to a vehicle catalogued in said mobile computer device through an algorithm stored in said mobile computer device.

18. The method of claim 16, comprising the step of accessing information regarding roughly estimated repair costs catalogued within said mobile computer device.
